(19) United States
(12) Patent Application Publication
(10) Pub. No.: US 2003/0183646 A1
(43) Pub. Date: Oct. 2, 2003

(54) Display unit, especially for bottles

(76) Inventors: Gary Souter, Staverton, Northamtonshire (GB); Philip Toovey, Banbury, Oxfordshire (GB)

Correspondence Address: Paul E Milliken, 9061 Wall Street NW, Massillon, OH, 44646-1676, US

(21) Appl. No.: 10/257,529

(22) PCT Filed: Apr. 10, 2001
(86) PCT No.: PCT/GB01/01614

(30) Foreign Application Priority Data
Apr. 15, 2000 (GB) 0009277.5

(51) Int. Cl. G07F 11/72

(52) U.S. Cl. 221/150 R

(57) ABSTRACT

A sales display unit (11) primarily for dispensing cooled drinks and comprising a housing (13) with refrigeration means therein, having an opening (18), an automatic feed system (21) located within the housing and on which goods (12) ate stored. The feed system (21) transports goods to the opening (18) where stop means (42) arrests the goods at or adjacent said opening (18) where said goods are accessible from without the housing.

### FIELD

This invention relates to sales display units and in particular to point-of-sale display units which may be used to display and dispense items for impulse sales in a retail or catering environment.

### BACKGROUND OF THE INVENTION

Display units are often used in shops or other commercial premises to display and dispense a particular line, or lines of goods which may often be produced by a single manufacturer. In particular, display units may be used in retail, restaurants, or canteen environments near to the points of sale, or payment to tempt customers to buy goods, particularly drinks and confectionary, on impulse whilst paying for other goods.

### STATEMENTS OF INVENTION

According to the invention there is provided a sales display unit comprising a housing with cooling means therein, an opening, an automatic feed system located within the housing and on which goods are stored, the feed system transporting goods to said opening, stop means arresting said goods at or adjacent said opening where said goods are accessible from without the housing.

The cooling means is preferably a built-in refrigeration unit.

Preferably, the housing is primarily used for the storage and sale of drinks packaged in bottles and/or cans.

Preferably, the feed system comprises a moveable flexible elongate belt, chain or band which herein after will be referred to as a band, preferably a flat section spiral spring, and the goods are moved by abutment means attached to the band. The abutment means is preferably a hook shape to accomodate the curved exterior of a can or bottle.

The, or each, band may be associated with a carrier having a channel along which the goods are transported, the band being located in the base of the channel.

Preferably, each band has only a single abutment means attached thereto and in use containers of pre-packaged goods are arranged in a linear array along the band with adjacent containers being in contact one with another, and the abutment means contacting a container at the end of said linear array so that the feed system can move the array of containers along the channel towards the opening.

When, the or each carrier is arranged so that the respective channel is oriented along a substantially vertical axis and it is enclosed on its open side by removable cover means, for example an open mesh wire cover or cage, or a transparent cover which allows the transported goods to be viewed.

Each carrier comprises two longitudinally extending parts each forming a sidewall of the channel and a respective side portion of the base thereof, the base side portions having mutually contacting edges having grooves therein which house and guide the band. Each carrier may have cooling means cooperating therewith so that the goods are cooled through contact with the carrier Preferably the carrier is formed from a thermally conductive material e.g. aluminium, the cooling means include cooling ducts formed integrally within said carrier.

The stop means have a detent to prevent goods from being ejected through the opening by the feed system. Preferably, the stop means and detent are formed integrally with the or each carrier and extend transversely of the respective channel.

The unit may include a plurality of substantially vertical carriers arranged in tandem and/or side-by side in the housing with the front carriers being covered by a single removable cover, preferably a transparent cover. The cover and housing may be decorated with advertising or company logos.

### DESCRIPTION OF THE DRAWINGS

The invention will be described by way of example only with reference to the accompanying drawings in which:

FIG.1 is an isometric part cut-away view of a sales display unit according to the present invention,

FIG.2 is front elevation of the unit of FIG.1,

FIG.3 is a sectional view taken on the line 111-111 of FIG.2,

FIG.4 is part sectioned isometric view of a carrier as is used in the unit in FIG.1,

FIG.5 is an enlarged detail from FIG.4 showing the feed spring and lifting cradle, and

FIG. 6 is an isometric part cut away view of a second embodiment of the present invention.

### DETAILED DESCRIPTION OF THE INVENTION

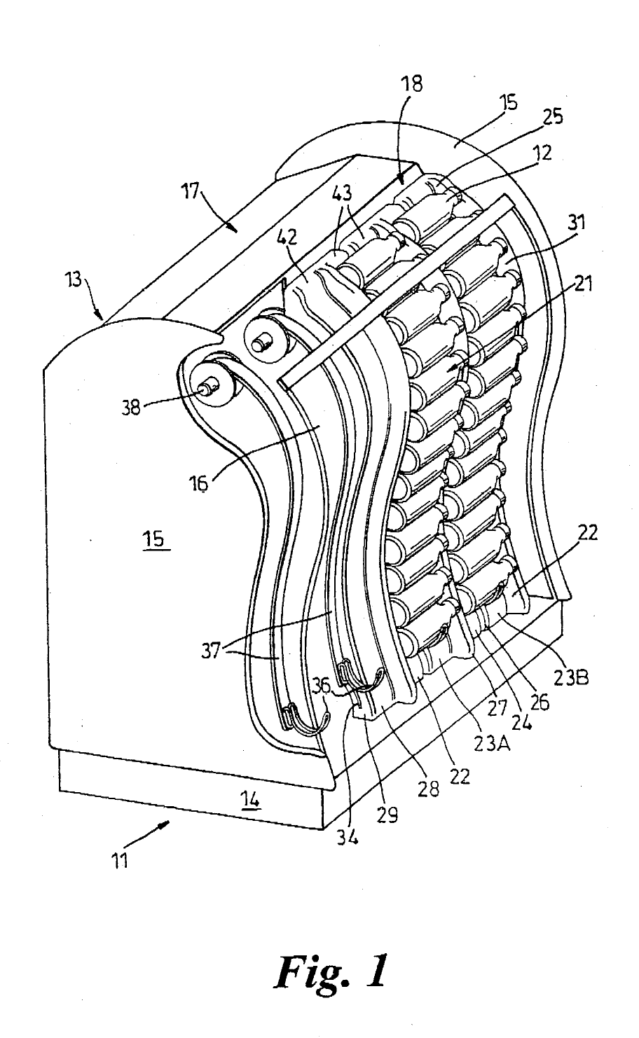

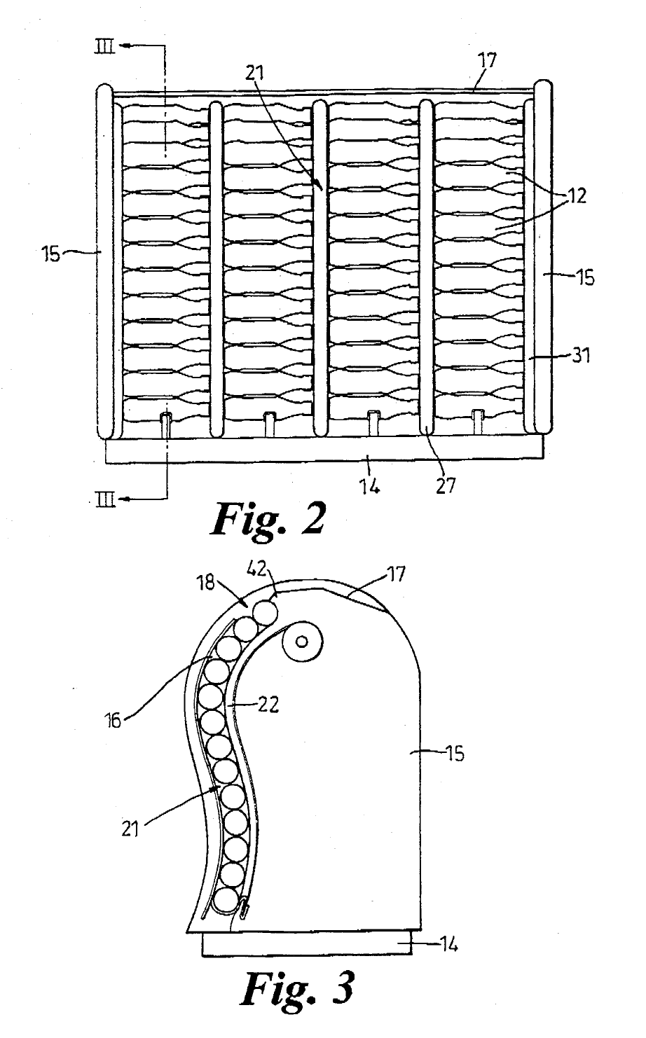

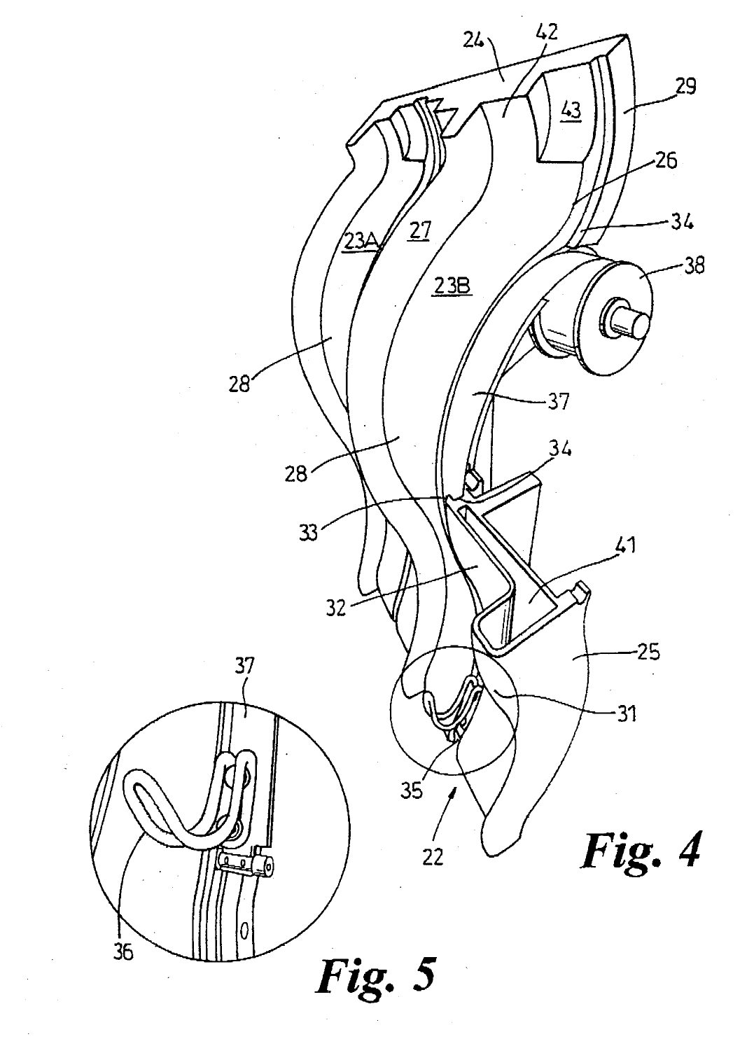

With reference to FIG. 1, there is shown a sales display and dispensing unit 11 for drinks which in this example are packaged in bottles 12. The unit 11 may be free standing or built into a display wall.

The unit 11 has a housing 13 which includes a plinth 14, side walls 15, removable front cover 16, and main wall 17 which extend between the two side walls at the rear and top portion of the housing. In the assembled condition, there is an opening 18 in the front top of the housing 13 giving access to the interior of the unit 11.

The housing 13 as shown has a curved contoured front but other shaped housing can be used within the spirit of the invention.

Containers 12 of pre-packaged goods e.g. soft drinks in bottles, are stored within the housing 13 on an automatic feed system 21 which transports the goods towards the opening 18 so that customers may remove the goods through the opening for purchase.

The feed and storage system 21 comprises a plurality of carriers 22, preferably four carriers 22 which are arranged side-by-side in the housing. The carriers 22 are similar to each other so that only one carrier will be described in detail to give an understanding of the Invention.

Each carrier 22 has an open channel 23 along which the bottles 12 are guided and transported. The channel 23 is humped and each carrier is formed from two parts 24,25 which are separated by a longitudinal split 26 which runs along the base of the channel 23. The carrier 22 is oriented so that the channel 23 which is humped extend along a substantially vertical axis. The inner part 24 (that is inner with respect to the housing sidewall 15) has an inverted “T” cross-section the leg of which forms a side wall 27 between two channels 23A & 23B, and the head of which forms one side portion 28 of the base of a respective channel. The side portions 28 each have a longitudinal edge 29 extending the length of the part 24. The outer part 25 has an “L” shaped cross-section, forming the outer sidewall 31 of the channel 23B and the other side portion 32 of the base of the channel 23B. The side portion 32 has a longitudinal edge 33 thereon extending the length of the part 25. The edges 29,33 have recesses and grooves 34 therein so that when the two parts 24,25 are assembled, with the edges 29,33 in abutment at the split 26, the recesses and grooves form a longitudinally extending slot 35 and passageway 34.

The pre-packaged goods 12 are transported along the channel 23 in the carrier 22 by a cradle 36, in this case shaped as a hook, which is moved along the slot 35 by a moveable band 37. The band 37 is accommodated in the passageway 34 and is preferably a flat section spiral spring forming part of a constant force spiral spring assembly 38 which is attached to the rear of the carrier 22. The spring assembly 38 is primed by hand and the carrier may be held in a detent (not shown). Bottles 12 are placed transversely into the channel 22 side by side with the cradle 36 acting directly against the adjacent end bottle when released to move the array of bottles along the channel.

The spring assembly 38 may also be primed by means of motors attached to the free end of the spring 37 by flexible connections such as chains or belts.

The cradle 36 may be fixed to other devices such as chains, or belts which may be moved by motors e.g. hydraulic, pneumatic or electrically operated motors as alternatives to the spring operated system.

The carrier parts 24,25 may be formed from a thermally conductive material e.g. aluminium, and have cooling channels or passageways 41 formed their so that coolant can be passed through the carriers 22 for cooling containers in contact with the carrier. The coolant is provided by a refrigeration unit 43 in the housing.

The upper portion of the carrier 22 has a stop means 42 which halts the movement of the bottles. The stop means 42 is an abutment located in proximity to the opening 18 and which extend across the upper end of the channel 23. The stop means 42 has a slight undercut thereon forming a detent to hold an adjacent bottle within the channel 23 under the load exerted by the spring assembly 38. A recess 43 is provided in the upper portion of each side portion 28 of the carrier to provide a clearance around a mid-portion of a bottle to assist removal from the housing.

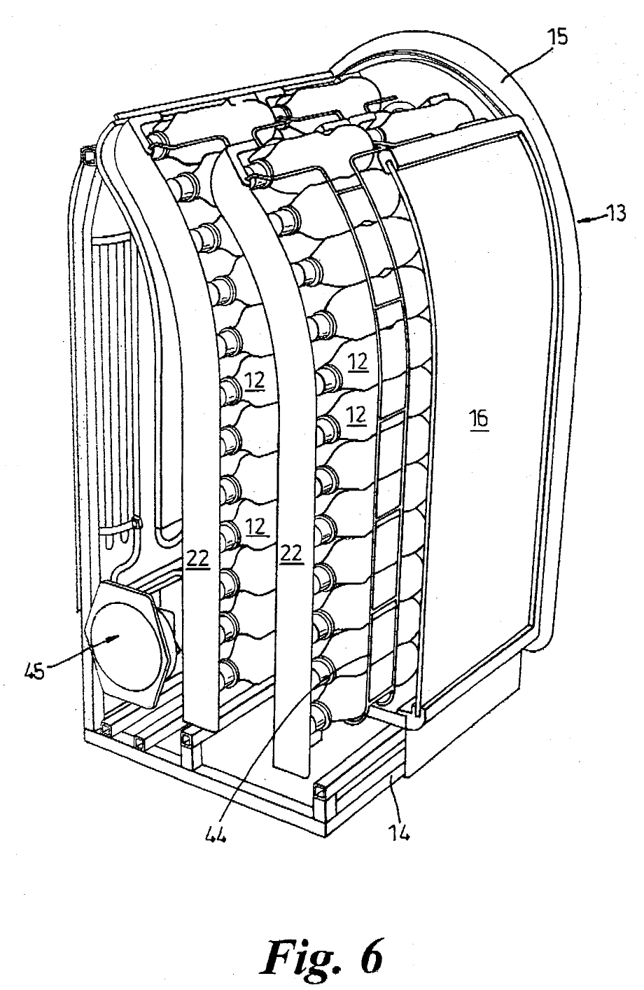

The channels 23 of the four carriers may be covered a open mesh cage 44, see FIG. 6, to hold the bottles in place, and/or by the shaped front cover 16. Both also act as a guide for movement of the bottles.

As a bottle 12 is removed from the top portion of each carrier. 22, the spring assembly 38 automatically propels the array of bottles upward until the next bottle contacts the stop means 42. When the carries 22 are empty, the unit can be re-filled by removing the front cover 16 and then either priming and filling the carriers 22 in situ, or removing the carriers 22 en-block for filling on the site or at a remote location.

In an alterative construction, shown in FIG. 6, the carriers 22 can be made independent of each other, by for example forming each carrier from two “L” section parts, and arranged differently e.g. behind each other instead of side-by-side, or in combinations of two.

The housing 13 includes a refrigeration unit 43 located within the housing 13 behind the carriers 22 for cooling the drinks stored in the unit. The refrigeration unit 43 may be located in the bottom of the housing 13 on the plinth 14 and may cool by circulation of cold air within the unit or by passing coolant through the carriers.

1. A drink sales display unit for drinks packaged in containers in the form of bottles and/or cans and comprising a housing with cooling means therein, an opening, an automatic feed system located within the housing and on which the, containers are stored, the feed system transporting said containers upwards towards said opening, stop means arresting said containers at or adjacent said opening where said containers are accessible from without the housing.

2. A unit as claimed in claim 1, wherein the feed system includes at least one moveable flexible band and the containers are moved by abutment means attached to the band.

3. A unit as claimed in claim 2, wherein the band consists of a spiral spring which propels the containers towards the opening.

4. A unit as claimed in claim 2 or claim 3, wherein the or each band is associated with a guideway in the form of a carrier having a channel along which the containers are transported, the band being located in the base of the channel.

5. A unit as claimed in claim. 4, wherein each band has only a single abutment means attached thereto and in use the bottles or cans are arranged in a linear array along the band with adjacent containers being in contact one with another, and the abutment means contacting a container at the end of said linear array so that the feed system can move the array of containers along the channel towards the opening.

6. A unit as claimed in claim 7 wherein the or each carrier is arranged with its channel oriented along a substantially vertical axis goods are held in the channel by cover means.

7. A unit as claimed in claim 6 wherein the cover is an open mesh wire cage.

8. A unit as claimed in any one of claims 4 to 7, wherein each carrier comprises two longitudinally extending parts each forming a sidewall of the channel and a respective side portion of the base thereof, the base side portions having mutually contacting edges having grooves therein which house and guide the band.

9. A unit as claimed in any one of claims 4 to 8, wherein each carrier has cooling means cooperating therewith so that the containers are cooled through contact with the carrier.

10. A unit as claimed in any one of claims 1 to 9, wherein the stop means have a detent to prevent goods from being ejected through the opening by the feed system.

11. A unit as claimed in claim 10 when dependant upon claims 5 to 8, wherein the stop means and detent are formed integrally with the carrier and extend transversely of the channel.

12. A unit as claimed in any one of claims 5 to 11, wherein the unit includes a plurality of substantially vertical carriers arranged either in tandem and/or side-by-side in the housing with the front carriers being covered by a single removable cover.

13. A unit as claimed claim 12 wherein each carrier is a removable from the housing for re-stocking.
